(19) United States
(12) Patent Application Publication
(10) Pub. No.: US 2004/0168539 A1
(43) Pub. Date: Sep. 2, 2004

(54) Brake handle with integral position sensing

(75) Inventor: William R. Rosencrantz, Sarasota, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/376,908

(22) Filed: Feb. 28, 2003

(51) Int. Cl. G05G 1/10

(52) U.S. Cl. 74/543

(57) ABSTRACT

A brake handle for a train or other vehicle has a grip that may be grasped by a human operator, a shaft that is fastened to the grip, a hub that is fastened to the shaft and is rotated by the shaft, a mounting block that is supported by the hub for rotating movement, and a sensor. The sensor has a rotating sensing portion (such as magnet) supported by the hub and a stationary sensing portion (such as a magnetic field sensing element) supported by the mounting block.

### TECHNICAL FIELD OF THE INVENTION

The present invention relates generally to a novel and improved brake handle for vehicles such as rail vehicles.

### BACKGROUND OF THE INVENTION

Prior art brake equipment for locomotives has typically been implemented with mechanical and pneumatic hardware. Such hardware has included various valves interconnected by a system of pneumatic pipes. At least one of the valves responds to movement by the train operator of a brake handle so as to regulate the pressure in a brake pipe in order to apply and release the brakes of the locomotive, the brakes of any additional locomotives, and/or the brakes of cars powered by the locomotive or locomotives.

Usually, the brake handle has a number of positions, such as the brake release position and the full brake position at the opposite ends of the travel of the brake handle. The brake handle moves between the brake release position and the full brake position through a number of intermediate positions sometimes referred to as the application zone.

Current brake handles use a system of gears and/or linkages to transmit the position of the handle to external sensors that sense the position of the handle. These sensors may be valves, as described above, or mechanical, optical, or magnetic switches or other devices that sense the position of the brake handle. Thus, as the operator moves the brake handle, the external sensors determine the position of the brake handle in order to appropriately operate the brake system. The use of external sensors consumes too much space and adds to the cost and complexity of the braking system.

The present invention overcomes one or more of these or other problems of known brake handles.

### SUMMARY OF THE INVENTION

According to one aspect of the present invention, a handle comprises a grip arranged to be grasped by a human operator, a shaft fastened to the grip, a hub fastened to the shaft and arranged to be moved rotationally by the shaft, a stationary mounting block supporting the hub for movement, and a sensor. The sensor has a moveable sensing portion supported by the hub and a stationary sensing portion supported by the stationary mounting block.

According to another aspect of the present invention, a method of controlling a vehicle comprises the following: converting movement of a human operator to mechanical movement of a shaft; rotating a hub in response to the movement of the shaft, wherein the hub is attached to the shaft and is supported by a mounting block; and, sensing rotation of the hub by a sensor having a rotating sensing portion supported by the hub and a stationary sensing portion supported by the mounting block.

According to yet another aspect of the present invention, a brake handle comprises a moveable shaft, a moveable member fixedly fastened to the moveable shaft and arranged to be moved by the moveable shaft, a stationary member supporting the moveable member for movement, and a sensor having a moveable sensor portion attached to the moveable member and a stationary sensor portion attached to the stationary member.

### BRIEF DESCRIPTION OF THE DRAWINGS

These and other features and advantages will become more apparent from a detailed consideration of the invention when taken in conjunction with the drawings in which:

FIG. 1 is an isometric top view of a brake handle according to one embodiment of the present invention;

FIG. 2 is an isometric bottom view of the brake handle shown in FIG. 1;

FIG. 3 is a cross-section side view of a handle shaft and hub of the brake handle shown in FIGS. 1 and 2;

FIG. 4 is a side view of a portion of the handle shaft and hub of the brake handle of FIGS. 1-3;

FIG. 5 is a side view of a sensing board of the brake handle shown in FIGS. 1 and 2;

FIGS. 6 and 7 illustrate another embodiment of the present invention; and,

FIG. 8 shows an operating environment for the brake handles of the present invention.

### DETAILED DESCRIPTION

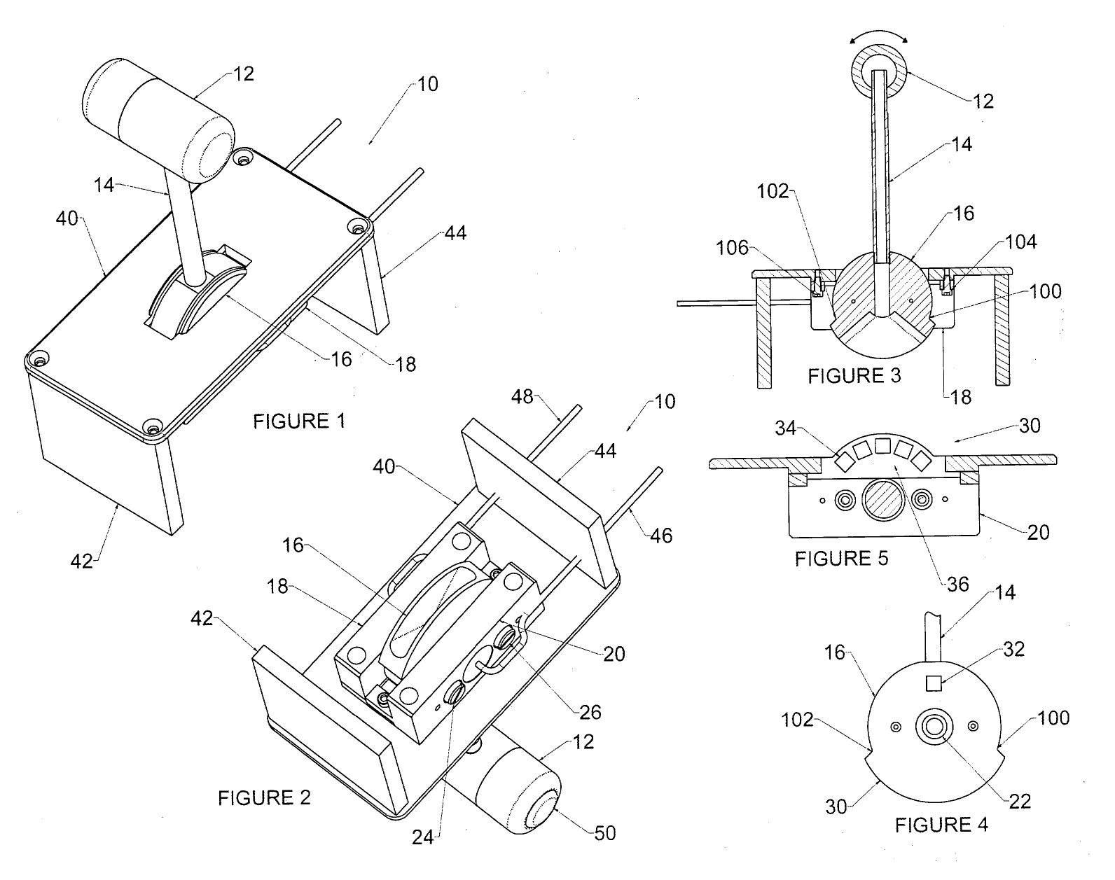

A brake handle 10 according to one embodiment of the present invention is shown in FIGS. 1-5 and includes a grip 12 that may be grasped by an operator in order to move the brake handle 10 to its various positions. The grip 12 is fastened to one end of a handle shaft 14 whose other end is appropriately fastened to a hub 16. The hub 16 is supported by bearings (not shown) to a pair of mounting blocks 18 and 20 through a hub shaft 22. Accordingly, as an operator grasps the grip 12 and moves the handle shaft 14 as shown by the arrow of FIG. 3, the hub 16 rotates on the hub shaft 22.

A force adjustment device 24 fitted through the mounting block 20 applies a restraining force on the hub 16 so as to adjust the force required to move the handle shaft 14 and rotate the hub 16. The force adjustment device 24, for example, may be a set screw that is threaded through the mounting block 20 and that engages the hub 16. For redundancy or otherwise, an additional force adjustment device 26 may also be provided through the mounting block 20 to adjust the force required to move the handle shaft 14 and rotate the hub 16.

An internal sensor 30 is provided in the area of the hub 16 and the mounting block 20 in order to sense the position of the hub 16 as the handle shaft 14 rotates the hub 16. The internal sensor 30 may be any type of sensor that can sense the rotation of the hub 16 and that can provide an appropriate signal corresponding to the rotation. For example, the internal sensor 30 may be a magnetic sensor including a magnet 32 mounted to one side of the hub 16 and a plurality of Hall sensors 34 mounted on a stationary board 36 fixed to the mounting block 20. The board 36, for example, may be a printed circuit board that supports electronics (not shown) that receive and process signals from the Hall sensors 34 in order to provide one or more output signals to appropriately control the brakes of a train on which the brake handle 10 is used.

Alternatively, the internal sensor 30 could be a potentiometer type sensor with a wiper contact on one of the hub 16 and the board 36 and a resistive element on the other of the hub 16 and the board 36. As a still further alternative, the internal sensor 30 could be an optical sensor with a light source on one of the hub 16 and the board 36 and one or more light sensors on the other of the hub 16 and the board 36. As yet a further alternative, the internal sensor 30 could be implemented as one or more cam operated switches such that a cam is mounted on one of the hub 16 and the board 36 and one or more mechanical switches are mounted on the other of the hub 16 and the board 36. Moreover, the internal sensor 30 could be implemented according to the Spiral Technology of Scientific Generics.

The mounting blocks 18 and 20 are fastened to a plate 40 and the plate 40, in turn, is fastened to supports 42 and 44 that may be attached to appropriate equipment in the control cab of a locomotive or other vehicle. The output signals from the internal sensor 30 may be provided from the brake handle 10 over a line 46. For redundancy, an additional internal sensor, similar to the internal sensor 30, may be provided in the area of the hub 16 and the mounting block 18 in order to sense the position of the hub 16 as the handle shaft 14 rotates the hub 16. The additional internal sensor also may be any type of sensor that can sense the rotation of the hub 16. For example, the additional internal sensor may be a magnetic sensor such as an additional magnet mounted to the other side of the hub 16 and a plurality of additional Hall sensors mounted on an additional board fixed to the mounting block 18. The additional board, for example, may also be a printed circuit board that supports electronics (not shown) that receive and process signals from the additional Hall sensors in order to provide one or more output signals to appropriately control the brakes of a train on which the brake handle 10 is used.

Similarly, the additional internal sensor could alternatively be a potentiometer, an optical sensor, or cam operated switches as discussed above, and may be implemented according to the aforementioned Spiral Technology. The output signals from the additional internal sensor may be provided from the brake handle 10 over a line 48.

Furthermore, a push button 50 may be provided on the grip 12 to operate a switch such as a dead man switch (not shown).

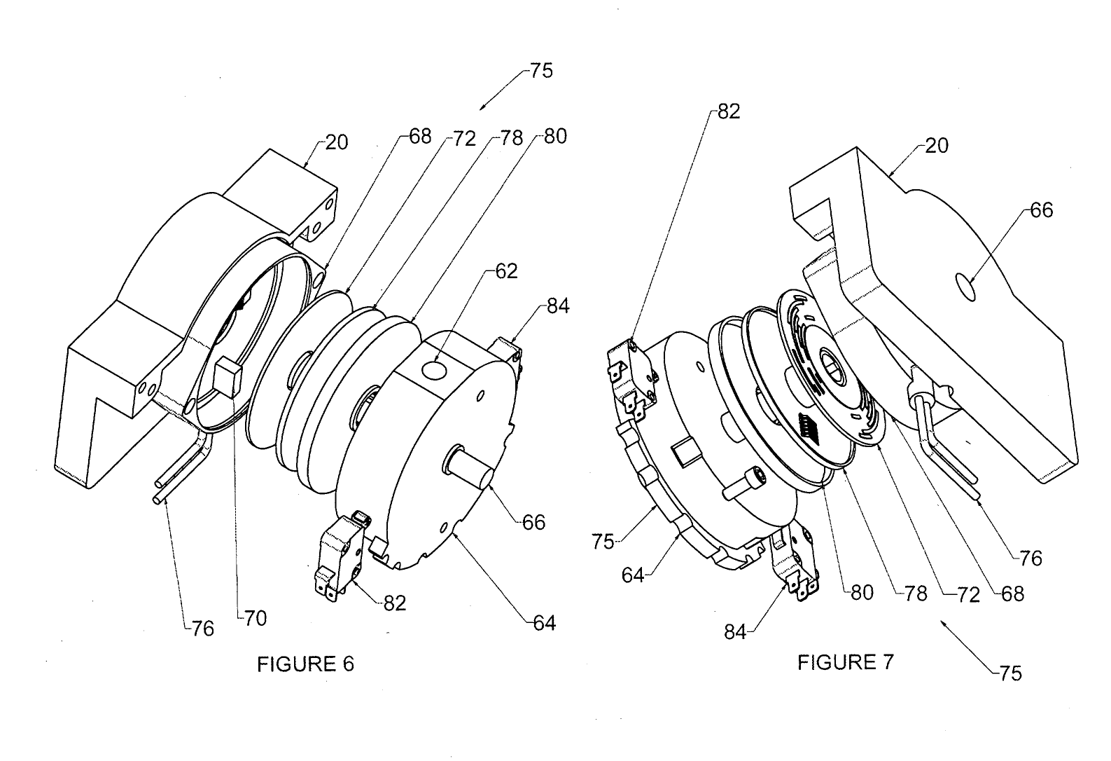

Another embodiment of a brake handle-60 is shown in FIGS. 6 and 7. The brake handles 10 and 60 may use some common elements and, therefore, the same reference numerals for these common elements are used in the description of the brake handle 60. Therefore, the handle shaft 14 may be received in a hole 62 of a hub 64 of the handle brake 60 so that the handle shaft 14 can be fastened to the hub 64. For example, the handle shaft 14 may be press fitted or threaded into the hole 62. The hub 64 is supported by bearings (not shown) to the mounting blocks 18 and 20 through a hub shaft 66. Accordingly, as an operator grasps the grip 12 and moves the handle shaft 14, the hub 64 rotates on the hub shaft 66.

A housing 68 is suitably fastened to the mounting block 20, and switch contacts 70 are fastened to the housing 68. Accordingly, neither the housing 68 nor the switch contacts 70 rotate as the hub 64 is rotated by the handle shaft 14. A rotating board 72 is attached to the hub shaft 66, and metal traces 74 are printed or otherwise formed on the rotating board 72 to establish current paths between selected ones of the switch contacts 70. Accordingly, the switch contacts 70 and the metal traces 74 form an internal sensor 75 of the brake handle 60. The current paths established by the switch contacts 70 and the metal traces 74 may be suitably output through a cable 76 so as to be received and processed in a manner to control braking of a train on which the brake handle 60 is used. The rotating board 72 is fastened to a rotating disk 78, and the rotating board 72 and the rotating disk 78 are housing in a rotating housing 80 that fits within the hub 64. The hub 64 may also act as a cam to operate stationary switches 82 and 84. The stationary switches 82 and 84, for example, may be limit switches.

Accordingly, as the operator grasps the grip 12 and moves the handle shaft 14 so as to rotate the hub 64, the rotating housing 80, the rotating disk 78, and the rotating board 72 also rotate commensurately. As the rotating board 72 rotates, one or more current paths are formed by the switch contacts 70 and the metal traces 74 in order to control braking and/or other functions of a train or other vehicle on which the brake handle 60 is used.

Alternatively, the internal sensor 75 may be a potentiometer type sensor with a wiper arm on one of the housing 68 and the rotating board 72 and a resistive element on the other of the housing 68 and the rotating board 72. As a still further alternative, the internal sensor 75 may be an optical sensor with a light source on one of the housing 68 and the rotating board 72 and one or more light sensors on the other of the housing 68 and the rotating board 72. Moreover, the internal sensor 75 may be implemented according to the aforementioned Spiral Technology.

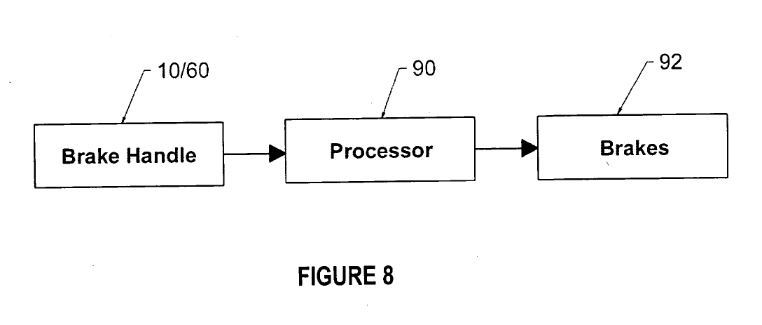

As discussed above and as shown in FIG. 8, the brake handles 10 and 60 may be used to control the brakes of a train or other vehicle. Thus, the brake handle 10/60 is coupled to a processor 90 that provides suitable outputs to control brakes 92 of a train or other vehicle. The processor 90 may be either internal or external to the brake handles 10 and 60.

Because the internal sensors 30 and 75 are mounted internally of the brake handles 10 and 60, no gears and/or linkages are required to couple the brake handles 10 and 60 to external sensors. As a result, the brake handles 10 and 60 are less complex and, therefore, more reliable than known brake handles. Also, the brake handles 10 and 60 are less costly than known brake handles. Moreover, the brake handles 10 and 60 use considerably less space in the control cab of a locomotive or other vehicle than known brake handles.

Certain modifications of the present invention have been discussed above. Other modifications will occur to those practicing in the art of the present invention. For example, the handles 10 and 60 are described above as brake handles. However, these handles can control functions other than braking and may, therefore, be referred to in the claims more generally. Alternatively or additionally, it is possible to use the handles 10 and 60 to control the speed and/or modes of a train or other vehicle.

Also, motion of the handle shaft 14 may be limited due to engagement by the handle shaft with the plate 40. Alternatively, the hub 16/64 may be provided with ridges 100 and 102 that engage corresponding stops 104 and 106 to limit motion of the handle shaft 14 and corresponding rotary motion of the hub 16/64. The stops 104 and 106 may be adjustable stops. For example, the stops 104 and 106 may be provided as adjustable screws.

Moreover, as discussed above, the internal sensor 30 may be provided redundantly as an additional internal sensor for the brake handle 10. Similarly, the internal sensor 75 may be provided redundantly as an additional internal sensor for the brake handle 60.

Furthermore, as described above, the hubs 16 and 64 are rotated on their corresponding hub shafts 22 and 66 in response to rotational movement of the handle 14. Alternatively, other forms of movement of the handle 14 and the hubs 16 and 64 may be provided. For example, the hubs 16 and 64 may be arranged to slide on their corresponding hub shafts 22 and 66 in response to sliding movement of the handle 14.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A handle comprising:
a grip arranged to be grasped by a human operator;
a shaft fastened to the grip;
a hub fastened to the shaft and arranged to be moved rotationally by the shaft;
a stationary mounting block supporting the hub for movement; and,
a sensor having a moveable sensing portion supported by the hub and a stationary sensing portion supported by the stationary mounting block.

2. The handle of claim 1 wherein the sensor comprises a magnetic sensor having at least one magnet and at least one magnetic sensing element, wherein one of the magnet and the magnetic sensing element is attached to the hub, and wherein the other of the magnet and the magnetic sensing element is attached to the mounting block.

3. The handle of claim 1 wherein the sensor comprises an optical sensor having at least one light source and at least one light sensing element, wherein one of the light source and the light sensing element is attached to the hub, and wherein the other of the light source and the light sensing element is attached to the mounting block.

4. The handle of claim 1 wherein the sensor comprises a potentiometer having at least one wiper arm and at least one resistive element, wherein one of the wiper arm and the resistive element is attached to the hub, and wherein the other of the wiper arm and the resistive element is attached to the mounting block.

5. The handle of claim 1 wherein the handle is coupled so as to control brakes of a vehicle.

6. The handle of claim 5 further comprising processing equipment coupling the handle to the brakes of the vehicle.

7. The handle of claim 5 wherein the brakes comprise brakes of a train.

8. The handle of claim 5 wherein the sensor comprises a magnetic sensor having at least one magnet and at least one magnetic sensing element, wherein one of the magnet and the magnetic sensing element is attached to the hub, and wherein the other of the magnet and the magnetic sensing element is attached to the mounting block.

9. The handle of claim 5 wherein the sensor comprises an optical sensor having at least one light source and at least one light sensing element, wherein one of the light source and the light sensing element is attached to the hub, and wherein the other of the light source and the light sensing element is attached to the mounting block.

10. The handle of claim 5 wherein the sensor comprises a potentiometer having at least one wiper arm and at least one resistive element, wherein one of the wiper arm and the resistive element is attached to the hub, and wherein the other of the wiper arm and the resistive element is attached to the mounting block.

11. The handle of claim 1 further comprising adjustable stops to limit motion of the shaft.

12. The handle of claim 1 wherein the shaft is supported by the hub for rotary movement.

13. A method of controlling a vehicle comprising:
converting movement of a human operator to mechanical movement of a shaft;
rotating a hub in response to the movement of the shaft, wherein the hub is attached to the shaft and is supported by a mounting block; and,
sensing rotation of the hub by a sensor having a rotating sensing portion supported by the hub and a stationary sensing portion supported by the mounting block.

14. The method of claim 13 wherein the sensing of rotation of the hub comprises sensing rotation of the hub by a magnetic sensor having at least one magnet and at least one magnetic sensing element, wherein one of the magnet and the magnetic sensing element is attached to the hub, and wherein the other of the magnet and the magnetic sensing element is attached to the mounting block.

15. The method of claim 13 wherein the sensing of rotation of the hub comprises sensing rotation of the hub by an optical sensor having at least one light source and at least one light sensing element, wherein one of the light source and the light sensing element is attached to the hub, and wherein the other of the light source and the light sensing element is attached to the mounting block.

16. The method of claim 13 wherein the sensing of rotation of the hub comprises sensing rotation of the hub by a potentiometer having at least one wiper arm and at least one resistive element, wherein one of the wiper arm and the resistive element is attached to the hub, and wherein the other of the wiper arm and the resistive element is attached to the mounting block.

17. The method of claim 13 further comprising controlling braking of the vehicle in response to the sensing of rotation of the hub.

18. The method of claim 17 wherein the brakes comprise brakes of a train.

19. The method of claim 17 wherein the sensing of rotation of the hub comprises sensing rotation of the hub by a magnetic sensor having at least one magnet and at least one magnetic sensing element, wherein one of the magnet and the magnetic sensing element is attached to the hub, and wherein the other of the magnet and the magnetic sensing element is attached to the mounting block.

20. The method of claim 17 wherein the sensing of rotation of the hub comprises sensing rotation of the hub by an optical sensor having at least one light source and at least one light sensing element, wherein one of the light source and the light sensing element is attached to the hub, and wherein the other of the light source and the light sensing element is attached to the mounting block.

21. The method of claim 17 wherein the sensing of rotation of the hub comprises sensing rotation of the hub by a potentiometer having at least one wiper arm and at least one resistive element, wherein one of the wiper arm and the resistive element is attached to the hub, and wherein the other of the wiper arm and the resistive element is attached to the mounting block.

22. The method of claim 13 further comprising limiting motion of the shaft by use of adjustable stops.

23. A brake handle comprising:
a moveable shaft;
a moveable member fixedly fastened to the moveable shaft and arranged to be moved by the moveable shaft;
a stationary member supporting the moveable member for movement; and,
a sensor having a moveable sensor portion attached to the moveable member and a stationary sensor portion attached to the stationary member.

24. The brake handle of claim 23 wherein the sensor comprises a magnetic sensor having at least one magnet and at least one magnetic sensing element, wherein one of the magnet and the magnetic sensing element is attached to the moveable member, and wherein the other of the magnet and the magnetic sensing element is attached to the stationary member.

25. The brake handle of claim 23 wherein the sensor comprises an optical sensor having at least one light source and at least one light sensing element, wherein one of the light source and the light sensing element is attached to the moveable member, and wherein the other of the light source and the light sensing element is attached to the stationary member.

26. The brake handle of claim 23 wherein the sensor comprises a potentiometer having at least one wiper arm and at least one resistive element, wherein one of the wiper arm and the resistive element is attached to the moveable member, and wherein the other of the wiper arm and the resistive element is attached to the stationary member.

27. The brake handle of claim 23 wherein the brake handle is coupled to the brakes of a vehicle.

28. The brake handle of claim 27 wherein the brakes comprise brakes of a train.

29. The brake handle of claim 28 wherein the sensor comprises a magnetic sensor having at least one magnet and at least one magnetic sensing element, wherein one of the magnet and the magnetic sensing element is attached to the moveable member, and wherein the other of the magnet and the magnetic sensing element is attached to the stationary member.

30. The brake handle of claim 28 wherein the sensor comprises an optical sensor having at least one light source and at least one light sensing element, wherein one of the light source and the light sensing element is attached to the moveable member, and wherein the other of the light source and the light sensing element is attached to the stationary member.

31. The brake handle of claim 28 wherein the sensor comprises a potentiometer having at least one wiper arm and at least one resistive element, wherein one of the wiper arm and the resistive element is attached to the moveable member, and wherein the other of the wiper arm and the resistive element is attached to the stationary member.

32. The brake handle of claim 28 further comprising adjustable stops to limit motion of the moveable shaft.

33. The brake handle of claim 23 wherein the shaft is supported by the hub for rotary movement.

34. The brake handle of claim 23 wherein the moveable member is supported by the stationary member for rotary movement.

35. The brake handle of claim 34 wherein the shaft is supported by the hub for rotary movement.
